(19) United States
(12) Patent Application Publication
(10) Pub. No.: US 2020/0262179 A1
(43) Pub. Date: Aug. 20, 2020

(54) RESIN LAMINATE, ELECTRONIC APPARATUS, AND MANUFACTURING METHOD FOR RESIN LAMINATE

(71) Applicant: LENOVO (SINGAPORE) PTE. LTD., Singapore (SG)

(72) Inventors: Fumitake Mizoguchi, Yokohama (JP); Seita Horikoshi, Yokohama (JP); Tsunenori Yanagisawa, Yokohama (JP); Takehito Yamauchi, Yokohama (JP)

(73) Assignee: LENOVO (SINGAPORE) PTE. LTD., SINGAPORE (SG)

(21) Appl. No.: 16/512,711

(22) Filed: Jul. 16, 2019

(30) Foreign Application Priority Data
Feb. 19, 2019 (JP) 2019027423

(51) Int. Cl. B32B 7/027; B32B 27/08; B32B 27/36; B32B 27/38; B32B 5/02

(52) U.S. Cl. CPC B32B 7/027; B32B 27/08; B32B 27/365; B32B 27/38; B32B 5/024; B32B 2250/24; B32B 2262/106; B32B 2307/3065; B32B 2457/00; B32B 2250/02; B32B 2307/30

(57) ABSTRACT

The present invention provides a resin laminate that suppresses the infiltration of a component contained in a lower resin layer into a surface resin layer in the resin laminate composed of a thermoplastic resin. The resin laminate includes a first thermoplastic resin layer positioned as the surface layer, and a second thermoplastic resin layer positioned beneath the first thermoplastic resin layer, wherein the glass transition temperature of the first thermoplastic resin layer is higher than the glass transition temperature of the second thermoplastic resin layer.

### FIELD OF THE INVENTION

The present invention relates to a resin laminate, an electronic apparatus, and a manufacturing method for a resin laminate.

### BACKGROUND OF THE INVENTION

An electronic apparatus, such as a portable laptop personal computer, has a foldable chassis (refer to, for example, Japanese Unexamined Patent Application Publication No. 2018-170371).

In the case where such a chassis is formed using a resin laminate, the resin laminate is preferably a thermoplastic resin which provides higher productivity, requiring a shorter processing time than a thermoset resin. However, regarding the resin laminate of a thermoplastic resin, there have been cases where, when heat is applied, a component contained in a lower resin layer infiltrates into a surface resin layer and inconveniently precipitates on a surface of the chassis.

### SUMMARY OF THE INVENTION

The present invention has been made with a view toward the above-described problem, and an object of the present invention is to suppress the infiltration of a component contained in a lower resin layer into a surface resin layer in a resin laminate of a thermoplastic resin.

To solve the problem described above, a resin laminate according to an aspect of the present invention includes: a first thermoplastic resin layer positioned as a surface layer; and a second thermoplastic resin layer positioned as a layer beneath the first thermoplastic resin layer, wherein the glass transition temperature of the first thermoplastic resin layer is higher than the glass transition temperature of the second thermoplastic resin layer.

Further, in the resin laminate, the first thermoplastic resin layer may be formed of fiber-reinforced plastic containing the fibers formed into fabric.

Further, in the resin laminate, the fibers may be carbon fibers.

Further, in the resin laminate, the second thermoplastic resin layer may contain a flame retardant made of red phosphorus.

Further, in the resin laminate, the first thermoplastic resin layer may be a polycarbonate resin layer, and the second thermoplastic resin layer may be an epoxy resin layer.

Further, an electronic apparatus according to another aspect of the present invention has at least a part of a chassis thereof formed of the resin laminate.

Further, a manufacturing method for a resin laminate according to yet another aspect of the present invention includes the steps of: placing a first thermoplastic resin layer on a second thermoplastic resin layer having a glass transition temperature which is lower than that of the first thermoplastic resin layer; and heating the first thermoplastic resin layer and the second thermoplastic resin layer at a temperature which is higher than the glass transition temperature of the second thermoplastic resin layer and which is lower than the glass transition temperature of the first thermoplastic resin layer thereby to bond the first thermoplastic resin layer and the second thermoplastic resin layer.

The present invention makes it possible to restrain the infiltration of a component contained in a lower resin layer into a surface resin layer in a resin laminate of a thermoplastic resin.

### BRIEF DESCRIPTION OF THE DRAWINGS

FIG. 1 is a perspective view of an electronic apparatus 1 in an embodiment of the present invention;

FIG. 2 is a rear view of the electronic apparatus 1 in an embodiment of the present invention;

FIG. 3 is a sectional view taken along arrow line X-X of a display chassis 3 illustrated in FIG. 2;

FIG. 4 is a graph illustrating the relationship between the temperature and the elasticity of a first thermoplastic resin layer 11 (PC) and a second thermoplastic resin layer 10 (epoxy) in the embodiment of the present invention; and

FIGS. 5A-C present explanatory diagrams illustrating the order of steps of the manufacturing method for a resin laminate in the embodiment of the present invention.

### DETAILED DESCRIPTION OF THE INVENTION

The following will describe an embodiment of the present invention with reference to the accompanying drawings.

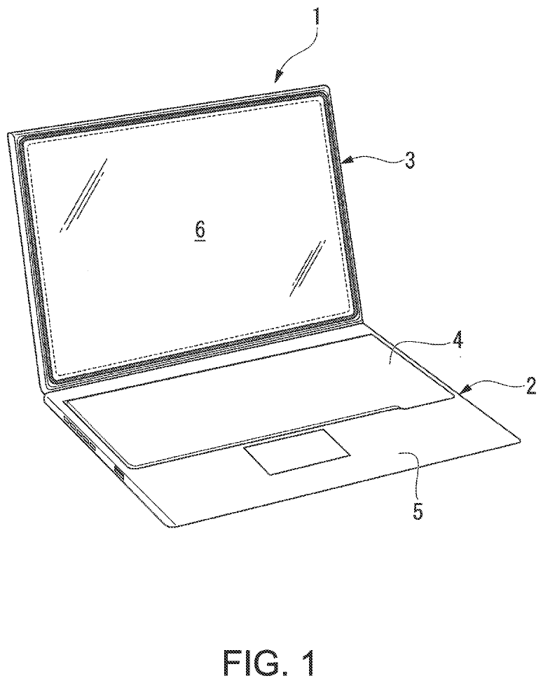

FIG. 1 is a perspective view of an electronic apparatus 1 in an embodiment of the present invention. FIG. is a rear view of the electronic apparatus 1 in the embodiment of the present invention.

As illustrated in FIG. 1, the electronic apparatus 1 of the present embodiment is a clamshell type laptop personal computer (a so-called notebook personal computer). The electronic apparatus 1 includes a system chassis 2 and a display chassis 3. The system chassis 2 and the display chassis 3 are openably connected by hinges, which are not illustrated.

The system chassis 2 is provided with a keyboard assembly 4, and a palm rest 5 is formed on the front side of the keyboard assembly 4. As is widely known, the system chassis 2 includes therein various types of electronic components, such as a processor, a motherboard, a wireless module, and a hard disk driver, which are not illustrated.

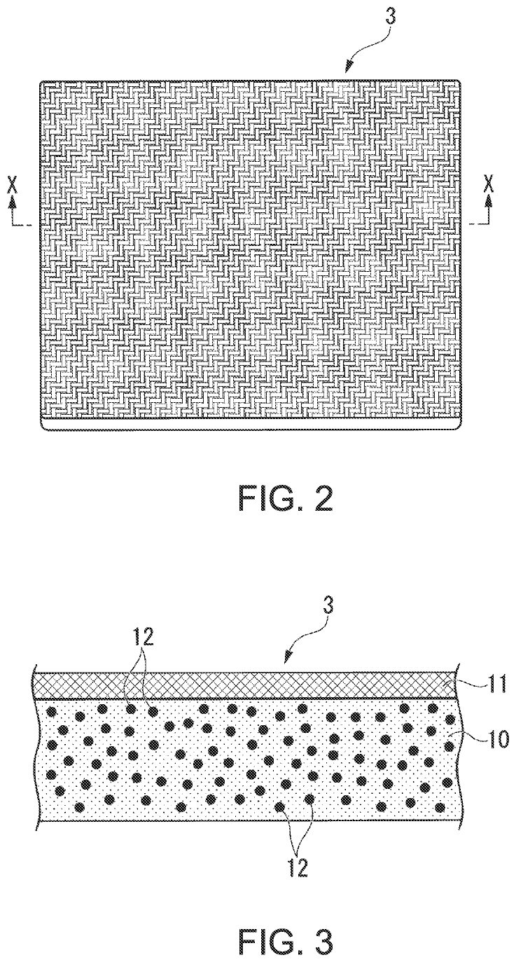

The display chassis 3 is provided with a display module 6. The display module 6 is formed of, for example, a liquid crystal display, an organic EL display, or the like. The display surface of the display module 6 may be a touch panel. As illustrated in FIG. 2, the outer surface of the display chassis 3 (the surface on the opposite side from the display module 6) is provided with a fabric design.

FIG. 3 is a sectional view taken along arrow line X-X of the display chassis 3 illustrated in FIG. 2.

As illustrated in FIG. 3, the display chassis 3 is formed of a resin laminate of a thermoplastic resin. Hereinafter, the thermoplastic resin layer which is positioned as the lower layer of the resin laminate and which provides the base material of the resin laminate will be referred to as a second thermoplastic resin layer 10. Further, the thermoplastic resin layer as a surface layer which is placed on and fused to the second thermoplastic resin layer 10 will be referred as a first thermoplastic resin layer 11.

The second thermoplastic resin layer 10 is formed of a thermoplastic CFRP (thermoplastic carbon fiber reinforced plastic) made of an epoxy resin layer. Further, the second thermoplastic resin layer 10, which provides the base material, is required to have flame retardancy as the chassis of the electronic apparatus 1, so that red phosphorus is added thereto as a flame retardant. Particles 12 (components) illustrated by black dots in FIG. 3 denote the red phosphorus added to the second thermoplastic resin layer 10.

The first thermoplastic resin layer 11 is formed of the thermoplastic CFRP composed of a polycarbonate resin layer. The first thermoplastic resin layer 11 is composed of the fiber reinforced plastic containing the fibers formed into fabric (the carbon fibers in the present embodiment), as illustrated in FIG. 2. As the fabric, desired fabric, such as plain-woven fabric, twill, UD (UniDirectional carbon) or the like, can be selected.

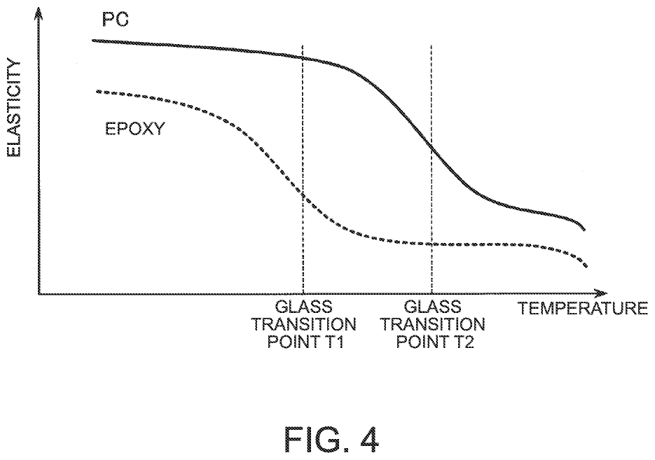

FIG. 4 is a graph illustrating the relationship between the temperature and the elasticity of the first thermoplastic resin layer 11 (PC) and the second thermoplastic resin layer 10 (epoxy) in the embodiment of the present invention. In the graph, T1 denotes the glass transition point (glass transition temperature) of the epoxy resin, and T2 denotes the glass transition point (glass transition temperature) of the polycarbonate resin.

As illustrated in FIG. 4, the glass transition temperature of the polycarbonate resin (the first thermoplastic resin layer 11) is higher than the glass transition temperature of the epoxy resin (the second thermoplastic resin layer 10).

More specifically, the glass transition temperature of the second thermoplastic resin layer 10 composed of the epoxy resin layer is, for example, 95° C., and the glass transition temperature of the first thermoplastic resin layer 11 composed of the polycarbonate resin is, for example, 150° C. The desirable molding temperature of the epoxy resin is 160° C., whereas the desirable molding temperature of the polycarbonate resin is 250° C. Hence, the glass transition temperature and the molding temperature have to be interpreted as different.

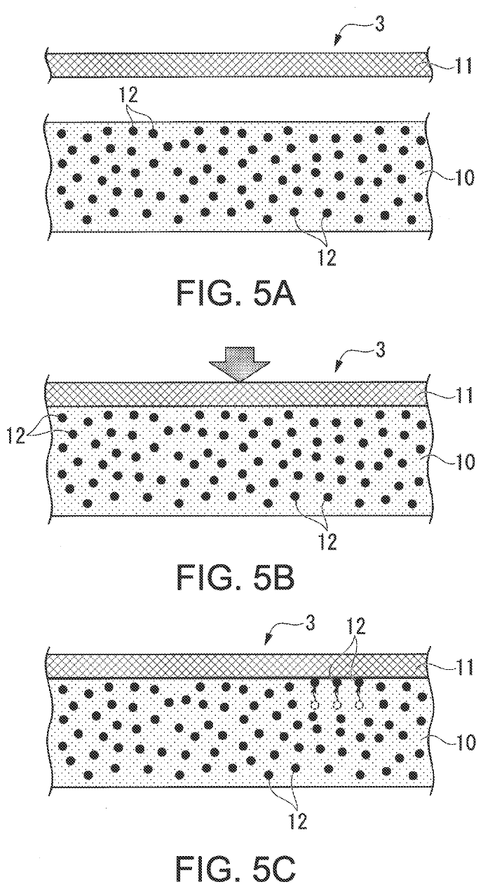

Referring to FIG. 5A to FIG. 5C, the following will describe the manufacturing method for the resin laminate in the present embodiment.

FIGS. 5A-C present the explanatory diagrams for describing the manufacturing method for the resin laminate in the order of steps in the embodiment of the present invention.

FIG. 5A illustrates the lamination step. In this step, the first thermoplastic resin layer 11 is laminated onto the second thermoplastic resin layer 10, the glass transition temperature of which is lower than that of the first thermoplastic resin layer 11. The second thermoplastic resin layer 10 is formed into a shape that satisfies the requirements as the display chassis 3 of the electronic apparatus 1. Meanwhile, the first thermoplastic resin layer 11 is formed like a sheet which is large enough to cover the outer surface of the display chassis 3. The fabric design which appears on the surface of the first thermoplastic resin layer 11 improves the aesthetic appearance of the electronic apparatus 1.

FIG. 5B illustrates a heating and pressing step. In this step, while pressing the first thermoplastic resin layer 11 onto the second thermoplastic resin layer 10, these layers are heated at a temperature that is higher than the glass transition temperature of the second thermoplastic resin layer 10 but lower than the glass transition temperature of the first thermoplastic resin layer 11. The first thermoplastic resin layer 11 and the second thermoplastic resin layer 10 are preferably pressed by a press machine, which is not illustrated. The heating temperature is preferably, for example, 100° C. to 140° C., which exceeds the glass transition temperature (95° C.) of the second thermoplastic resin layer 10 (the epoxy resin) but does not exceed the glass transition temperature (150° C.) of the first thermoplastic resin layer 11 (the polycarbonate resin).

FIG. 5C illustrates a fusion bonding step. In this step, the first thermoplastic resin layer 11 and the second thermoplastic resin layer 10 are bonded by fusion. In the heating and pressing step described above, the temperature of the second thermoplastic resin layer 10 exceeds the glass transition temperature, so that the second thermoplastic resin layer 10 fuses to the first thermoplastic resin layer 11, causing the second thermoplastic resin layer 10 and the first thermoplastic resin layer 11 to be bonded. At this time, the first thermoplastic resin layer 11 has not yet reached the glass transition temperature, thus suppressing the infiltration of the particles 12 of the red phosphorus added to the second thermoplastic resin layer 10 into the first thermoplastic resin layer 11 (refer to the particles 12 of the red phosphorus indicated by the chain line in FIG. 5C).

Therefore, for example, the particles 12 will not infiltrate through the grain of the fabric and precipitate red onto the surface of the first thermoplastic resin layer 11, thus preventing the fabric design or original colors from being affected. In other words, the electronic apparatus 1 provided with the display chassis 3 having the excellent fabric design illustrated in FIG. 2 can be manufactured.

The above has described the embodiment of the present invention in detail with reference to the accompanying drawings; however, the specific configurations are not limited to the above-described embodiment, and include designs or the like in a range that does not deviate from the spirit of the present invention. The configurations described in the foregoing embodiment can be freely combined insofar as the combinations do not give rise to contradictions.

For example, the foregoing embodiment has illustrated the example in which the first thermoplastic resin layer 11 and the second thermoplastic resin layer 10 are formed of the carbon fiber reinforced plastic. Alternatively, however, the first thermoplastic resin layer 11 and the second thermoplastic resin layer 10 may be formed of other fiber reinforced plastic, such as glass fiber reinforced plastic.

Further, if the carbon fiber reinforced plastic is not used, then the component contained in the second thermoplastic resin layer 10 does not necessarily have to be the particles 12 of the red phosphorus composed of a flame retardant.

Further, the foregoing embodiment has been predicated on the use of the fiber reinforced plastic containing fibers. However, even if the fiber reinforced plastic is not used, a component contained in the thermoplastic resin lower layer could infiltrate into the thermoplastic resin surface layer. Therefore, the first thermoplastic resin layer 11 and the second thermoplastic resin layer 10 do not necessarily have to be formed of fiber reinforced plastic.

Further, the foregoing embodiment has been described, taking, for example, the laptop personal computer as the example of electronic apparatus; however, the present invention is not limited thereto, and can be applied also to other electronic apparatuses, such as a tablet.

1. A resin laminate comprising:
a first thermoplastic resin layer positioned as a surface layer; and
a second thermoplastic resin layer positioned adjacent the first thermoplastic resin layer,
wherein the glass transition temperature of the first thermoplastic resin layer is higher than the glass transition temperature of the second thermoplastic resin layer.

2. The resin laminate according to claim 1, wherein the first thermoplastic resin layer is composed of a fiber reinforced plastic that contains fibers formed into fabric.

3. The resin laminate according to claim 2, wherein the fibers are carbon fibers.

4. The resin laminate according to claim 1, wherein the second thermoplastic resin layer contains a flame retardant made of red phosphorus.

5. The resin laminate according to claim 1,
wherein the first thermoplastic resin layer is a polycarbonate resin layer, and
the second thermoplastic resin layer is an epoxy resin layer.

6. An electronic apparatus, comprising:
a chassis, at least a part of which includes a resin laminate having:
a first thermoplastic resin layer positioned as a surface layer; and
a second thermoplastic resin layer positioned adjacent the first thermoplastic resin layer,
wherein the glass transition temperature of the first thermoplastic resin layer is higher than the glass transition temperature of the second thermoplastic resin layer.

7. A manufacturing method for a resin laminate comprising the steps of:
placing a first thermoplastic resin layer on a second thermoplastic resin layer having a glass transition temperature which is lower than that of the first thermoplastic resin layer; and
heating the first thermoplastic resin layer and the second thermoplastic resin layer at a temperature which is higher than the glass transition temperature of the second thermoplastic resin layer and which is lower than the glass transition temperature of the first thermoplastic resin layer
bonding the first thermoplastic resin layer and the second thermoplastic resin layer.
